(19) United States
(12) Patent Application Publication
(10) Pub. No.: US 2014/0065031 A1
(43) Pub. Date: Mar. 6, 2014

(54) CONTAINER, TUBE OR CHEMICAL APPARATUS WITH COLOR INDICATOR, AND COMPOSITE SEMI-FINISHED PRODUCT WITH COLOR INDICATOR FOR PRODUCING A CONTAINER, TUBE OR CHEMICAL APPARATUS

(71) Applicants: Achim LITZENBURGER, Fischbach/Nahe (DE); Simona AG, Kirn (DE)

(72) Inventor: Achim K.E. Litzenburger, Fischbach/Nahe (DE)

(73) Assignee: Simona AG, Kirn (DE)

(21) Appl. No.: 14/116,667

(22) PCT Filed: May 2, 2012
(86) PCT No.: PCT/EP2012/058005

§ 371 Date: Nov. 8, 2013

(30) Foreign Application Priority Data
May 17, 2011 (DE) 10 2011 075 998.0

(51) Int. Cl. B01L 3/00

(52) U.S. Cl. CPC B01L 3/52
USPC 422/405; 422/401

(57) ABSTRACT

The invention relates to a container, tube or chemical apparatus, in particular for the construction of chemical apparatus for storing or for transporting aggressive storage media, comprising a solid inner layer with the inner side of which the storage medium can come into contact and which is made of a thermoplastic that is resistant to the storage medium, comprising an adhesion-promoting layer applied to the outer side of the inner layer, which is made of a textile sheet-like structure, and comprising a carrier layer applied to the outer side of the adhesion-promoting layer for providing mechanical support to the layer structure, wherein between the inner layer and the outer layer an indicator layer is provided, the material of the indicator layer being discolored by components of the storage medium which permeate through the inner layer.

The invention relates to a container, tube or chemical apparatus, in particular for the construction of chemical apparatus for storing or for transporting aggressive storage media according to the preamble of claim 1.

Further, the invention relates to composite semi-finished products for producing such containers, tubes or chemical apparatus. Generic components for the construction of chemical apparatus are known from EP 0 577 134 B1 and from U.S. Pat. No. 3,723,234. The components described there have a multi-layered structure. The inner layer is formed by a thermoplastic that is resistant to the storage medium to be received. The properties of the thermoplastic which in the generic components forms a solid inner layer can be specifically configured to be resistant to the storage medium coming into contact with the inner side. Due to their inherent structure, said thermoplastics are only insufficiently stable from a mechanical point of view, in particular at higher temperatures. Therefore, it is envisaged that an adhesion-promoting layer with a sheet-like textile structure is applied to the outer side of the inner layer. For example, said adhesion-promoting layer can be a crocheted, woven or knitted glass fiber element with a sheet-like textile structure. The adhesion-promoting layer has the task of allowing the application of a carrier layer which supports the inner layer. By means of the adhesion-promoting layer, an adhesion between the inner layer and the outer carrier layer is realized that is strong enough for the chemically resistant inner layer to be sufficiently supported by the mechanically high-strength carrier layer.

In other words, this means that the generic components have a multi-layered structure whose solid inner layer is resistant to the respectively present chemical aggressions, such as by aggressive chemical substances, the adhesion-promoting layer providing the necessary adhesion between the inert or chemically resistant inner layer and the outer, mechanically high-strength carrier layer. As far as composite semi-finished products are concerned, said composite semi-finished products initially only comprise the chemically inert inner layer and the adhesion-promoting layer applied thereto. Said composite semi-finished products can then be completed by the respective user applying the outer carrier layer to produce the composite components according to the invention.

The known composite components of chemical apparatus construction are used in many different applications for transporting and storing chemically aggressive storage media, such as strong acids and bases. It is the property of said aggressive storage media that components of said storage media diffuse into the thermoplastic material and there cause damage to the material. Damage to the known composite components occurs in particular if the components of the storage media diffuse to the depth of the adhesion-promoting layer and there cause a delamination between the inner layer and the carrier layer. With such a delamination, the mechanical cohesion between the carrier layer and the inner layer is damaged and thus the mechanical rigidity of the respective component is severely diminished. Since diffusion of components of the storage medium into the material of the inner layer cannot be entirely precluded, the known components used to have to be regularly inspected and replaced if necessary, for which specific cycles of inspection and replacement are to be observed. These cycles of inspection and replacement presuppose standard stress levels on the material and cannot take into account the specific strain on the material caused by diffusing components of the storage media.

Tubes and semi-finished tubes in the sense of the invention shall include all composite components having a closed cross section. Fittings for producing tube connections, in particular, are tubes in the sense of the invention.

Starting from this state of the art, it is therefore the object of the present invention to propose new composite components and composite semi-finished products for producing containers, tubes or chemical apparatus, in which the specific strain on and damage to the material caused by components of the storage medium which diffuse into said material can be recognized without difficulty in order to provide for a replacement of the respective components/parts if necessary and as needed.

This object is attained by a container, a tube or a chemical apparatus according to the teaching of claim 1. Further, the object is attained by a composite semi-finished product according to the independent claim 14. Preferred embodiments of the invention are the subject matter of the dependent claims.

According to the invention, it is envisaged that between the inner layer and the outer layer an indicator layer is provided. The material of the indicator layer is characterized in that the components of the storage medium which have permeated the inner layer cause a color reaction in the indicator layer. In other words, this means that the indicator layer is discolored by the components of the storage medium which have penetrated the inner layer. This discoloring can then be observed through the typically transparent carrier layer or, in the case of a suitable laminate structure, through the carrier layer and thus corresponding damage can be concluded. Depending on the degree of the discoloring, a corresponding measure can be taken, in particular the replacement of the respective component.

In order to realize the principle of an indicator layer according to the invention, an additional material can be inserted between the inner layer and the carrier layer. In view of a production as inexpensive as possible, however, it is advantageous if the adhesion-promoting layer also assumes the function of the indicator layer. In other words, this means that the material of the adhesion-promoting layer can be discolored by the components of the storage medium which permeate through the inner layer. As a result, the color reaction according to the invention takes place due to a chemical reaction between the components of the storage medium which have penetrated the inner layer and the material of the adhesion-promoting layer. In this way, additional material can be omitted, leading to significant savings in terms of work effort. According to a preferred embodiment it is provided that the indicator layer or the adhesion-promoting layer serving as indicator layer is discolored by acid components since strong acids can cause massive damage to the composite component.

The manner in which the color reaction according to the invention between the components of the storage medium and the indicator layer or the adhesion-promoting layer serving as indicator layer is achieved is substantially optional. According to a preferred embodiment, it is envisaged that the indicator layer, respectively the adhesion-promoting layer, contains organic or inorganic compounds, in particular compounds of transition metals, such as iron oxide. Acid components permeating through the inner layer, in particular, can cause a color reaction with these compounds and thus produce the indicator effect according to the invention.

Further, it is particularly advantageous if the indicator layer or the adhesion-promoting layer serving as indicator layer is at least partially made of glass fibers. If these glass fibers contain compounds with transition metals, such as iron oxide, the glass fibers can be discolored by the components permeating through the inner layer and thus cause the color reaction according to the invention. Also, adhesion-promoting layers in a hybrid form can be employed. This means that apart from the discolorable glass fibers at least one other type of fiber is used which may also tend to color-react, and together they form the adhesion-promoting layer. It is advantageous in this combination that in the case of decreasing adhesion rigidity of the discoloring glass fibers due to chemical aggression, the mechanical functionality of the unit is ensured by the additional fibers until it can be replaced.

In this context, the glass fibers of the indicator layer or the glass fibers of the adhesion-promoting layer serving as indicator layer can form a woven, knitted, crocheted or other textile sheet-like structure. Textile sheet-structures of this sort made of a woven glass fiber structure, knitted glass fiber structure or crocheted glass fiber structure are particularly suitable for forming an unbreakable mechanical unit of the inner layer, the adhesion-promoting layer and the carrier layer.

The glass fiber material for forming the indicator layer or the adhesion-promoting layer serving as indicator layer should have a tensile strength of greater than 3000 MPa at room temperature. Additionally, at rising temperatures, the tensile strength of the glass fibers should be greater than the tensile strength at room temperature. Thus, it is particularly advantageous if the tensile strength of the glass fibers at about 250° C. is at least 10% greater than the tensile strength of the glass fibers at room temperature.

The elastic modulus of the indicator layer or of the adhesion-promoting layer serving as indicator layer should preferably lie in the range of greater than or equal to 80 GPa.

The breaking elongation of the glass fibers should preferably lie in the range of greater than or equal to 3%.

The density of the glass fibers should preferably be in the range of greater than or equal to 2.5 g/cm³.

The softening temperature of the indicator layer or of the adhesion-promoting layer serving as indicator layer should preferably be greater than or equal to 900° C.

The melting temperature should preferably be greater than or equal to 1300° C.

According to the invention, not only composite components, namely containers, tubes or chemical apparatus comprising an indicator layer, are proposed, but also composite semi-finished products in which a corresponding indicator layer is already comprised, which can be used for producing corresponding composite components, namely containers, tubes or chemical apparatus. The composite semi-finished products are characterized in that they already comprise the chemically inert inner layer and the adhesion-promoting layer and the indicator layer. In the case that the adhesion-promoting layer itself serves as indicator layer, the composite semi-finished products according to the invention only comprise the chemically inert inner layer and the adhesion-promoting layer serving as indicator layer.

1. A container, tube or chemical apparatus, in particular for the construction of chemical apparatus for storing or for transporting aggressive storage media, comprising a solid inner layer with the inner side of which the storage medium can come into contact and which is made of a thermoplastic that is resistant to the storage medium, comprising an adhesion-promoting layer applied to the outer side of the inner layer, which is made of a textile sheet-like structure, and comprising a carrier layer applied to the outer side of the adhesion-promoting layer for providing mechanical support to the layer structure,
wherein
between the inner layer and the outer layer, an indicator layer is provided, the material of the indicator layer being discolored by components of the storage medium which permeate through the inner layer.

2. The container, tube or chemical apparatus according to claim 1,
wherein
the adhesion-promoting layer serves as indicator layer and the material of the adhesion-promoting layer is discolored by components of the storage medium which permeate through the inner layer.

3. The container, tube or chemical apparatus according to claim 1,
wherein
the indicator layer or the adhesion-promoting layer serving as indicator layer is discolored by acid components which permeate through the inner layer.

4. The container, tube or chemical apparatus according to claim 1,
wherein
the indicator layer or the adhesion-promoting layer serving as indicator layer comprises organic or inorganic compounds, which react with components of the storage medium which permeate through the inner layer by changing color.

5. The container, tube or chemical apparatus according to claim 1,
wherein
the indicator layer or the adhesion-promoting layer serving as indicator layer is at least partially made of glass fibers, the glass fibers being discolored by the components of the storage medium which permeate through the inner layer.

6. The container, tube or chemical apparatus according to claim 5, wherein
the glass fibers of the indicator layer or the glass fibers of the adhesion-promoting layer serving as indicator layer form a woven or knitted or crocheted structure.

7. The container, tube or chemical apparatus according to claim 5,
wherein
at room temperature, the glass fibers of the indicator layer or the glass fibers of the adhesion-promoting layer serving as indicator layer have a tensile strength of greater than 3000 MPa.

8. The container, tube or chemical apparatus according to claim 5,
wherein
the tensile strength of the glass fibers in the indicator layer or the tensile strength of the glass fibers in the adhesion-promoting layer serving as indicator layer increases at temperatures above room temperature, in particular that, at a temperature of 250° C., the tensile strength of the glass fibers in the indicator layer or the tensile strength of the glass fibers in the adhesion-promoting layer serving as indicator layer is at least 10% higher than the tensile strength of the glass fibers at room temperature.

9. The container, tube or chemical apparatus according to claim 5,
wherein
the glass fibers of the indicator layer or the glass fibers of the adhesion-promoting layer serving as indicator layer have an elastic modulus of greater than or equal to 80 GPa.

10. The container, tube or chemical apparatus according to claim 5,
wherein
the glass fibers of the indicator layer or the glass fibers of the adhesion-promoting layer serving as indicator layer have a breaking elongation of greater than or equal to 3%.

11. The container, tube or chemical apparatus according to claim 5,
wherein
the glass fibers of the indicator layer or the glass fibers of the adhesion-promoting layer serving as indicator layer have a density of greater than or equal to 2.5 g/cm³.

12. The container, tube or chemical apparatus according to claim 5,
wherein
the glass fibers of the indicator layer or the glass fibers of the adhesion-promoting layer serving as indicator layer have a softening temperature of greater than or equal to 900° C.

13. The container, tube or chemical apparatus according to claim 5,
wherein
the glass fibers of the indicator layer or the glass fibers of the adhesion-promoting layer serving as indicator layer have a melting temperature of greater than or equal to 1300° C.

14. A composite semi-finished product for producing a container, tube or chemical apparatus, comprising a solid inner layer with the inner side of which the storage medium can come into contact and which is made of a thermoplastic that is resistant to the storage medium, comprising an adhesion-promoting layer applied to the outer side of the inner layer, which is made of a textile sheet-like structure,
wherein
on the outer side of the inner layer and/or on the adhesion-promoting layer an indicator layer is provided, the material of the indicator layer being discolored by components of the storage medium which permeate through the inner layer, wherein by applying a carrier layer, provided for mechanically supporting the layer structure, on the outer side of the adhesion-promoting layer, a container, tube or chemical apparatus according to claim 1 can be formed.

15. The container, tube or chemical apparatus according to claim 4, wherein the indicator layer or the adhesion-promoting layer serving as indicator layer comprises compounds of transition metals.

16. The container, tube or chemical apparatus according to claim 4, wherein the indicator layer or the adhesion-promoting layer serving as indicator layer comprises iron oxide.
